(19) United States
(12) Patent Application Publication
(10) Pub. No.: US 2006/0248578 A1
(43) Pub. Date: Nov. 2, 2006

(54) Method, system, and program product for connecting a client to a network

(75) Inventor: Guy S. Denton, Raleigh, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/119,436

(22) Filed: Apr. 28, 2005

(51) Int. Cl. H04L 9/32; G06K 9/00; G06F 17/30; G06F 15/16; G06F 7/04; G06F 7/58; G06K 19/00

(52) U.S. Cl. 726/5; 726/7; 726/6

(57) ABSTRACT

Under the present invention, both user credentials and software credentials are authenticated before the connection is permitted. To this extent, one or more user credentials are received on the client (e.g., from a user). Thereafter, a software agent, typically running on the client, will determine whether one or more software modules identified in a list of required software modules have been installed on the client. For each software module installed on the client, the agent will generate a software credential. The user credential(s) and the software credential(s) will then be sent to the server, which will allow the connection if the user credential(s) are valid, and a valid software credential is provided for each software module identified in the list of required software modules.

### FIELD OF THE INVENTION

In general, the present invention relates to a method, system and program product for connecting a client to a network. Specifically, the present invention relates to a method, system and program product that authenticates both a user of the client as well as the software loaded thereon before providing a full connection to the network.

### BACKGROUND OF THE INVENTION

As computer networks have become an integral part of society, so has the need for improved security. Currently, most networks perform a user-based authentication before allowing a user, or a client device he/she is operating, to establish a connection therewith. The most typical form of user-based authentication is based on a user identification and password. This type of authentication is not only utilized to establish network connectivity in the workplace, but it has also become the standard for many websites and on-line services.

Unfortunately, ensuring that users are who they say they are is not the only concern in network computing. Specifically, the continued evolution of computer viruses, spyware, adware and the like have LED to growing concerns among both individual computer users and network operators. For example, in many cases, a user can innocently transfer a virus to a computer network after a connection therewith has been established. To this extent, many network administrators have implemented policies requiring certain programs such as antivirus software to be installed on a client device before a connection is established.

Unfortunately, policing these policies has traditionally been left up to the individual users. That is, the policies are typically implemented only as a set of guidelines that are left up to the user to ensure are met. With such an implementation, there is no guarantee that the guidelines are met before a connection to the network is established. As such, the propagation of viruses and the like will only continue to grow. This is especially the case as more workers become mobile/remote and utilize laptops and other “portable” computing devices in lieu of their work location computer. That is, it can be substantially more difficult to ensure compliance of a mobile computing device than a work location-based computing device that the network operators can directly access.

In view of the foregoing, there exits a need for a method, system and program product for connecting a client to a network. Specifically, a need exists for a system that is capable of authenticating both a user, as well as required software on the client that is seeking to establish the connection to the network.

### SUMMARY OF THE INVENTION

In general, the present invention provides a method, system and program product for connecting a client to a network. Specifically, under the present invention, both user credentials and software credentials are authenticated before the connection is permitted. To this extent, one or more user credentials are received on the client (e.g., from a user). Thereafter, a software agent, typically running on the client, will determine whether one or more software modules identified in a list of required software modules have been installed on the client. For each software module installed on the client, the agent will generate a software credential. The user credential(s) and the software credential(s) will then be sent to the server, which will allow the connection if the user credential(s) are valid, and a valid software credential is provided for each software module identified in the list of required software modules.

A first aspect of the present invention provides a method for connecting a client to a network, comprising: receiving one or more user credentials on the client; determining with a software agent whether one or more software modules identified in a list of required software modules have been installed on the client; generating a software credential for each of the one or more software modules determined to be installed on the client; sending the one or more user credentials and the one or more software credentials to a server; and connecting the client to the network if the one or more user credentials are valid, and a valid software credential is provided for each software module identified in the list of required software modules.

A second aspect of the present invention provides a system for connecting a client to a network, comprising: a system for receiving one or more user credentials on the client; a system for determining whether one or more software modules identified in a list of required software modules have been installed on the client; a system for generating a software credential for each of the one or more software modules determined to be installed on the client; and a system for sending the one or more user credentials and the one or more software credentials to a server, wherein the client is connected to the network if the one or more user credentials are valid, and a valid software credential is provided for each software module identified in the list of required software modules.

A third aspect of the present invention provides a program product stored on a computer readable medium for connecting a client to a network, the computer readable medium comprising program code for performing the following steps: receiving one or more user credentials on the client; determining whether one or more software modules identified in a list of required software modules have been installed on the client; generating a software credential for each of the one or more software modules determined to be installed on the client; and sending the one or more user credentials and the one or more software credentials to a server, wherein the client is connected to the network if the one or more user credentials are valid, and a valid software credential is provided for each software module identified in the list of required software modules.

A fourth aspect of the present invention provides a method for deploying an application for connecting a client to a network, comprising: providing a computer infrastructure being operable to: receive a user credential and a security credential for each of one or more software modules determined to be loaded on the client; authenticate the user credential and the one or more security credentials to determine their validity; and permit the connection to the network if the user credential is valid and if a valid software credential has been provided for each software module identified in a list of required software modules.

A fifth aspect of the present invention provides computer software embodied as a propagated signal for connecting a client to a network, the computer software comprising instructions to cause a computer system to perform the following functions: receive a user credential and a security credential for each of one or more software modules determined to be loaded on the client; authenticate the user credential and the one or more security credentials to determine their validity; and permit the connection to the network if the user credential is valid and if a valid software credential has been provided for each software module identified in a list of required software modules, wherein the connection is not permitted if any of the software modules in the list of required software modules are not loaded on the client.

Therefore, the present invention provides a method, system and program product for connecting a client to a network.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for connecting a client to a network according to the present invention.

FIG. 2 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

As indicated above, the present invention provides a method, system and program product for connecting a client to a network. Specifically, under the present invention, both user credentials and software credentials are authenticated before the connection is permitted. To this extent, one or more user credentials are received on the client (e.g., from a user). Thereafter, a software agent, typically running on the client, will determine whether one or more software modules identified in a list of required software modules have been installed on the client. For each software module installed on the client, the agent will generate a software credential. The user credential(s) and the software credential(s) will then be sent to the server, which will allow the connection if the user credential(s) are valid, and a valid software credential is provided for each software module identified in the list of required software modules.

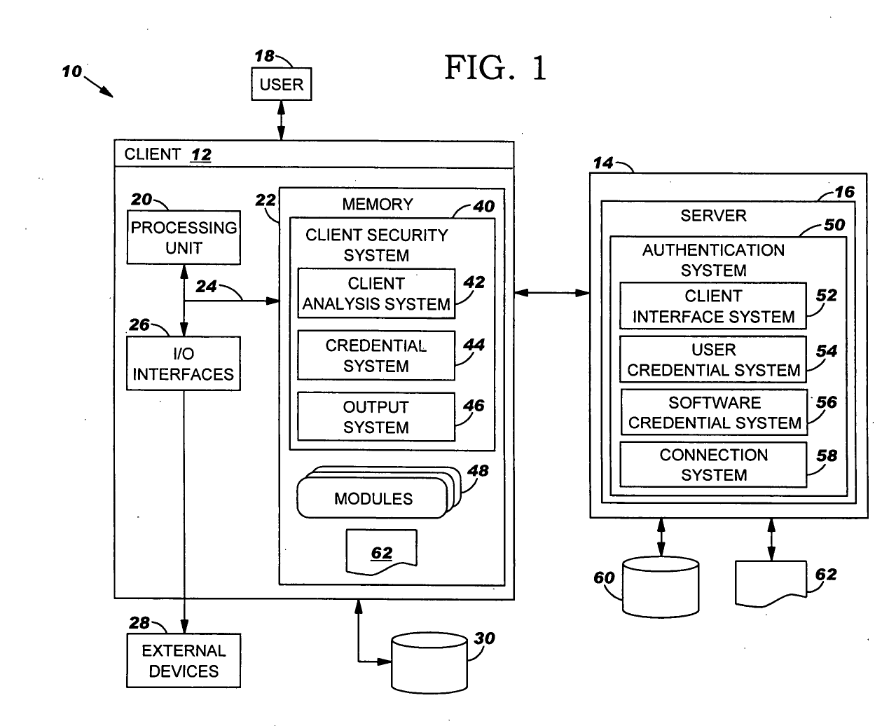

Referring now to FIG. 1, a system 10 for connecting a client 12 to a network 14 is shown. As depicted, network 14 includes server 16. It should be understood, however, that network 14 will likely include other components (e.g., hardware, software, etc.) that are not shown in FIG. 1 for brevity purposes. Moreover, network 14 can comprise any combination of various types of communications links. For example, network 14 can comprise addressable connections that may utilize any combination of wired and/or wireless transmission methods. Further, network 14 an comprise one or more of any type of network, including the Internet, a wide area network (WAN), a local area network (LAN), a virtual private network (VPN), etc. Where communications occur via the Internet, connectivity could be provided by conventional TCP/IP sockets-based protocol, and client 12 could utilize an Internet service provider to establish connectivity to the Internet. Still yet, it should be understood that client 12 and server 16 can be any type of computer devices capable of carrying out their respective functions. Examples of such include, among others, a handheld device, a laptop computer, a desktop computer, a workstation, etc.

In any event, client 12 is shown including a processing unit 20, a memory 22, a bus 24, and input/output (I/O) interfaces 26. Further, client 12 is shown in communication with external I/O devices/resources 28 and a storage system 30. In general, processing unit 20 executes computer program code, such as client security system 40, that is stored in memory 22 and/or storage system 30. While executing computer program code, processor 20 can read and/or write data, to/from memory 22, storage system 30, and/or I/O interfaces 26. Bus 24 provides a communication link between the components in client 12. External devices 28 can comprise any device (e.g., keyboard, pointing device, display, etc.) that enables a user to interact with client 12 and/or any device (e.g., network card, modem, etc.) that enables client 12 to communicate with one or more other computing devices, such server 16.

Communications between client 12 and server 16 can occur over one or more networks. Client 12 is only representative of various possible computer infrastructures that can include numerous combinations of hardware. For example, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processor, etc.) not shown in FIG. 1 can be included in client 12. Moreover, if client 12 comprises a handheld device or the like, it is understood that one or more external devices 28 (e.g., a display) and/or storage system 30 could be contained within client 12, not externally as shown.

Storage system 30 can be any type of system (e.g., a database) capable of providing storage for information (e.g., environment details, variables, etc.) under the present invention. As such, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into client 12. It should also be understood that although not shown for brevity purposes, server 16 will include computerized components similar to client 12.

Shown in memory 22 of client 12 is client security system 40, which will gather credentials/information for both user 18 as well as software modules 48 loaded on client 12 to ensure that the security needed for client 12 to connected to network 14 is present. As shown, client security system 40 includes client analysis system 42, credential system 44 and output system 46. As will be further described below, client security system 40 is typically a software agent or the like that is provided to client 12. However, this need not be the case. Shown loaded on server 16 (e.g., in memory) is authentication system 50, which will communicate the requirements for establishing a connection with network 14 to client 12, and will receive the credential information from client 12 to determine if such requirements are met. It is understood, however, that the depiction of client security system 40 and authentication system 50 of FIG. 1 is intended to be illustrative only and that their respective functionality provided thereby could be implemented by a different configuration of sub-systems.

### ILLUSTRATIVE EXAMPLE

In an illustrative example, assume that client 12 is a laptop computer with which user 18 is attempting to connect to his/her workplace computer network 14 (e.g., via server 16). In a typical embodiment, client security system 40 will be loaded on client before the connection is established or attempted. In one embodiment, client security system 40 is communicated to client 12 from server 16, via client interface system 52. However, this need not be the case. Rather, client security system 40 could be loaded on client 12 independent of interaction with server 16 (e.g., from a computer readable medium such as a CD-ROM). In any event, as indicated above, client security system 40 typically comprises a software agent that is configured to examine client 12 both at the user level and the software level. Thus, user 18 will initially provide one or more user credentials such as a user identification and a password. These user credential(s) will be received by client security system 40 (e.g., by credential system 44).

Under the present invention, client analysis system 42 will analyze client 12 to determine whether one or more software modules identified in a list of required software modules 62 is loaded on client 12. In general, list of required software modules 62 includes the software modules that are required for establishing a connection with network 14. Examples of such software modules include, among others, the following: a particular operating system, a particular operating system level, particular antivirus software, a particular antivirus software level, a particular application, a particular application level, a particular security patch, a particular security patch level, particular spyware software, a particular spyware software level, particular adware software and a particular adware software level. It should be understood that list of required software modules 62 is typically provided directly to client 12 (e.g., with client security system/agent 40). However, it could alternatively be provided to a location with which client 12 has access (e.g., storage unit 30).

In any event, client analysis system 42 can query client 12 to determine what software modules 48 are loaded thereon, or automatically analyze client 12 to determine the same. In any event, since the determination of software modules 48 could consume an appreciable amount of time, client 12 can optionally be granted temporary connection to network 14 by connection system 58 (of authentication system 50). This temporary connection could expire after a predetermined amount of time in the event the analysis and authentication of client 12 is not completed. In a typical embodiment, client analysis system 42 will identify the software modules 48 identified in list of required software modules 62 that are loaded on client 12, as well as those that are not loaded on client 12. For example, assume that list of required software modules 62 contains the following software modules: software patch “A,” operating system “X,” Level “2.0” and antivirus software “Z.” “Level “3.0.” Further assume that all of these software modules except for antivirus software “Z.” “Level “3.0” were determined to be are loaded on client (e.g., as software modules 48). In this event, client analysis system 42 can output meta data resembling the following two lists:

### I. Software Modules Loaded

### Software Patch “A”

### Operating System “X,” Level “2.0”

### II. Software Modules Absent

### Antivirus Software “Z,” Level “3.0”

However, if client 12 actually included all three of the required software modules (e.g., the actual programs or the incorrect versions thereof), the “Software Modules Absent” list could simply state “NONE” (or something similar), it or could be eliminated entirely.

Regardless, for each software module 48 identified by client analysis system 42, credential system 44 will generate a software credential using Message Digest 5 (MD5) technology. As known, MD5 is an algorithm that is used to verify data integrity through the creation of a 128-bit message digest from data input (which may be a message of any length) that is claimed to be as unique to that specific data as a fingerprint is to the specific individual. In a typical embodiment, the security credential for each software module will at least identify the software program and its corresponding version.

Once the software credential(s) have been generated, output system 46 will communicate the same along with the user credential(s) to server 16 where they will be received by client interface system 52. In a typically embodiment, client 12 and server 16 can communicate using the Diffie-Hellman key agreement protocol (also called exponential key agreement), which allows client 12 and server 16 to undertake secure communication (e.g., it allows client 12 and server 16 to exchange their secret data checksums over an insecure medium without any prior secrets). Upon receipt, user credential system 54 and software credential system 56 will attempt to authenticate the user credential(s) and the software credential(s) to determine their validity. Authenticating the user credential(s) can be accomplished using any known technique. For example 802.1x port based authentication at a switch level could be employed. In any event, the user credential(s) (e.g., user identification and password) will be compared by user credential system 52 to those stored in directory 60. If a match is established, then the user credentials have been authenticated and are valid. To this extent, directory 60 can be a Lightweight Directory Access Protocol (LDAP) directory 60 and server 16 can be a LDAP server.

Software credential system 56 will compare the details of software modules 48, as identified in the software credential(s), to the requirements as identified in list of required software modules 62. As indicated above, software credential(s) will typically identify the particular software program(s) and its corresponding version(s). This information will be compared to the requirements contained in list 62. Connection system 58 will establish the desired connection only if the user credential(s) are valid, and if a valid software credential is provided for each required software module identified in list 62. Thus, if the user credential(s) were not valid, no connection would be permitted. Moreover, if client 12 lacked a required software module (e.g., an actual program or an incorrect version), no connection would be permitted.

As indicated above, client 12 might have been permitted a temporary connection to network 14 pending the outcome of the process of the present invention. If the process is successful, the connection will no longer be temporary. However, if the process is unsuccessful, the connection will be terminated. In addition, as mentioned above, if the examination process is not completed within a predetermined amount of time, the temporary connection will be terminated and the process will be continued the next time client 12 seeks a connection to network 14.

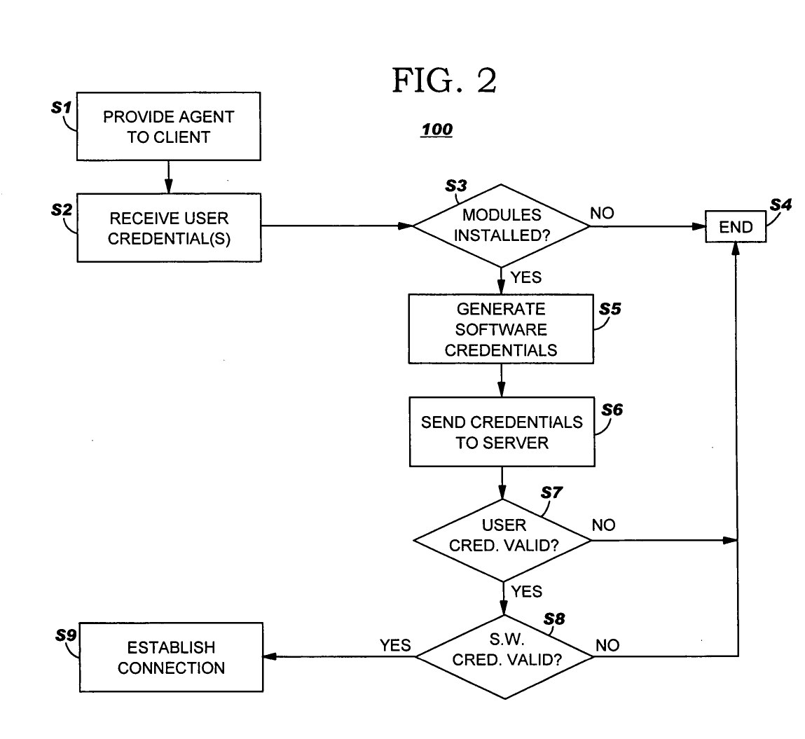

Referring now to FIG. 2, a method flow diagram 100 according to the present invention is shown. First step S1 is to provide a software agent to the client. Second step S2 is to receive one or more user credentials on the client. Third step S3 is to determine with the software agent whether one or more software modules identified in a list of required software modules have been installed on the client. If not, the process is ended in step S4. If, however, one or more such modules are found on the client, a software credential is generated for each in step S5. Then, in step S6, the user credential(s) and the software credential(s) are sent to the server. In step S7, it is determined whether the user credential(s) are valid. If not, the process is ended. If, however, the user credential(s) are valid, it is determined in step S8 whether a valid software credential has been provided for each software module identified in the list of required software modules. If not, the process is terminated. If, however, a valid software connection has been provided for each software module identified in the list, the client is connected to the network in step S9.

It should be appreciated that the teachings of the present invention could be offered as a business method on a subscription, advertising, and/or fee basis. For example, client security system 40, (FIG. 1) and/or a computer infrastructure such as client 12 and/or server 16 (FIG. 1) could be generated, maintained, supported and/or deployed by a service provider that offers the functions described herein for customers. That is, a service provider could offer connect a client to a network as shown and discussed above. To this extent, the invention can further comprise providing a computer infrastructure and deploying an application that is operable to perform the invention to the computer infrastructure.

It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product that is stored on a computer-readable medium and/or embodied as a propagated signal communicated between two or more systems, which comprises all the respective features enabling the implementation of the methods described herein, and which—when loaded in a computer system/deployed to a computing infrastructure—is able to carry out these methods. Computer program product, application, software program, program, and software, are synonymous in the present context and mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

I claim:

1. A method for connecting a client to a network, comprising:
receiving one or more user credentials on the client;
determining with a software agent whether one or more software modules identified in a list of required software modules have been installed on the client;
generating a software credential for each of the one or more software modules determined to be installed on the client;
sending the one or more user credentials and the one or more software credentials to a server; and
connecting the client to the network if the one or more user credentials are valid, and a valid software credential is provided for each software module identified in the list of required software modules.

2. The method of claim 1, further comprising providing the software agent to the client.

3. The method of claim 1, further comprising identifying, with the software agent, any software modules in the list of required software modules that are missing from the client.

4. The method of claim 1, wherein the list of required software modules comprises at least one required software module selected from the group consisting of a particular operating system, a particular operating system level, particular antivirus software, a particular antivirus software level, a particular application, a particular application level, a particular security patch, a particular security patch level, particular spyware software, a particular spyware software level, particular adware software and a particular adware software level.

5. The method of claim 1, wherein the list of required software modules is stored on the server and is accessible to the agent.

6. The method of claim 1, further comprising authenticating the one or more user credentials and the one or more software credentials on the server to determine their validity, prior to the connecting step.

7. The method of claim 6, wherein the server is a Lightweight Directory Access Protocol (LDAP) server.

8. A system for connecting a client to a network, comprising:
a system for receiving one or more user credentials on the client;
a system for determining whether one or more software modules identified in a list of required software modules have been installed on the client;
a system for generating a software credential for each of the one or more software modules determined to be installed on the client; and
a system for sending the one or more user credentials and the one or more software credentials to a server, wherein the client is connected to the network if the one or more user credentials are valid, and a valid software credential is provided for each software module identified in the list of required software modules.

9. The system of claim 8, wherein the system comprises a software agent.

10. The system of claim 9, wherein the software agent is loaded on the client.

11. The system of claim 8, further comprising a system for identifying any software modules in the list of required software modules that are missing from the client.

12. The system of claim 8, wherein the list of required software modules comprises at least one required software module selected from the group consisting of a particular operating system, a particular operating system level, particular antivirus software, a particular antivirus software level, a particular application, a particular application level, a particular security patch, a particular security patch level, particular spyware software, a particular spyware software level, particular adware software and a particular adware software level.

13. The system of claim 8, wherein the list of required software modules is stored on the server and is accessible to the client.

14. The system of claim 8, further comprising:
a system for authenticating the one or more user credentials; and
a system for authenticating the one or more software credentials.

15. The system of claim 14, wherein the server is a Lightweight Directory Access Protocol (LDAP) server.

16. A program product stored on a computer readable medium for connecting a client to a network, the computer readable medium comprising program code for performing the following steps:
receiving one or more user credentials on the client;
determining whether one or more software modules identified in a list of required software modules have been installed on the client;
generating a software credential for each of the one or more software modules determined to be installed on the client; and
sending the one or more user credentials and the one or more software credentials to a server, wherein the client is connected to the network if the one or more user credentials are valid, and a valid software credential is provided for each software module identified in the list of required software modules.

17. The program product of claim 16, wherein the program product comprises software agent.

18. The program product of claim 17, wherein the software agent is loaded on the client.

19. The program product of claim 16, wherein the computer readable medium further comprises program code for performing the following step:
identifying any software modules in the list of required software modules that are missing from the client.

20. The program product of claim 16, wherein the list of required software modules comprises at least one required software module selected from the group consisting of a particular operating system, a particular operating system level, particular antivirus software, a particular antivirus software level, a particular application, a particular application level, a particular security patch, a particular security patch level, particular spyware software, a particular spyware software level, particular adware software and a particular adware software level.

21. The program product of claim 16, wherein the list of required software modules is stored on the server and is accessible to the client.

22. The program product of claim 16, wherein the server is a Lightweight Directory Access Protocol (LDAP) server.

23. A method for deploying an application for connecting a client to a network, comprising:
providing a computer infrastructure being operable to:
receive a user credential and a security credential for each of one or more software modules determined to be loaded on the client;
authenticate the user credential and the one or more security credentials to determine their validity; and
permit the connection to the network if the user credential is valid and if a valid software credential has been provided for each software module identified in a list of required software modules.
